(19) United States
(12) Patent Application Publication
(10) Pub. No.: US 2018/0213728 A1
(43) Pub. Date: Aug. 2, 2018

(54) PLANTER BASE ATTACHMENT FOR OPEN-ENDED PRODUCTS

(71) Applicant: Harold Lorain Kelly, Roxboro, NC (US)

(72) Inventor: Harold Lorain Kelly, Roxboro, NC (US)

(21) Appl. No.: 15/885,627

(22) Filed: Jan. 31, 2018

Related U.S. Application Data
(60) Provisional application No. 62/499,605, filed on Jan. 31, 2017.

(51) Int. Cl. A01G 9/04; A01G 9/02; A01G 27/02

(52) U.S. Cl. CPC A01G 9/042; A01G 2009/003; A01G 27/02; A01G 9/02

(57) ABSTRACT

A number of planter base attachments are disclosed which can be fitted to an open-ended product, such as a plastic drainage pipe, to create a planter. The planter base attachment incorporates a base with raised sidewalls which fit into an open end of an open-ended product. The raised sidewalls engage the interior sidewalls of the open-ended product to create a tight fitting. Despite this tight fit, the planter base attachment allows excess moisture to drain through drainage routes disposed in the raised sidewalls. These drainage routes direct moisture to a catchment lip or tray connected to the base. A shelf sits transverse to the raise sidewalls and serves as the bottom side of the planter, which holds in growth media and adds rigidity to the attachment's overall structure.

### CLAIM OF PRIORITY

This application claims priority to U.S. Provisional Patent Application Ser. No. 62/499,605, filed Jan. 31, 2017, the entire disclosure of which is hereby expressly incorporated by reference herein.

### FIELD OF TECHNOLOGY

This disclosure relates generally to horticultural planters and, more particularly, to an attachment which can be used to assemble planters from open-ended products.

### BACKGROUND

Most mid and large-sized planters are heavy, expensive, susceptible to environmental damage, and are hard to relocate. Furthermore, materials typically used to construct planters (e.g., metal, plastic) can promote elevated and undesirable temperatures in the root zone, hindering plant growth and increasing evapotranspiration resulting in more frequent watering.

Readily available manufactured products, such as plastic corrugated drain pipes or culvert pipes may be used as sidewalls for planters, but current solutions usually involve filling a large portion of these sidewalls with gravel and burying a length of the sidewall to facilitate proper drainage. However, this needlessly sacrifices sidewall material, creates an immovable planter, and is not cost-effective to setup, maintain or keep watered. As such, these configurations are limited to particular environments and are not easily adaptable to commercial and residential applications where the pipes cannot be seated into and stabilized by soil or other pliable permeable material. Placed on a concrete pad, a solid deck or patio, or other impermeable surface, an open bottom planter will lack stability, have poor internal drainage from the planter, and may cause damage or stain the surface on which it's placed.

Thus, there exists a need for a base that can be fitted to open-ended potentially recyclable products such as culvert pipes, drainage pipes, corrugated pipes, or other open-ended objects of various materials and shapes to create a planter with proper drainage and growth media holding capacity.

### SUMMARY

Disclosed are one or more planter base attachment apparatuses for converting an open-ended product into a planter.

In one aspect, a planter base attachment incorporates a base having one or more raised sidewalls. When applying the planter base attachment to one end of an open-ended product, a portion of the raised sidewalls engages an interior surface of the sidewalls of the open-ended product. The engagement may be frictional, e.g., via surface-to-surface contact, a compressible beveled edge, a rubber gasket; or mechanical in nature, e.g., nut/bolt, screw, rivet, threaded fasteners. Other methods of interlocking two surfaces or holding two surfaces almost or completely flush against one another are contemplated.

The raised sidewalls may allow drainage through one or more drainage routes incorporated therein. Each drainage route has one or more inlets, one or more outlets, and one or more channels. Inlets may accept excess moisture from within the planter. Channels may carry the excess moisture from the inlet, through the raised sidewalls, and to the outlets. The outlets allow the excess moisture to exit through the base. The excess moisture may drain from the drainage route(s) to a catchment lip coupled to the base.

The inlet may be disposed at the top of the raised sidewall(s) to receive excess moisture into the channel. The channel may be a grooved portion of the raised sidewall(s). The outlet may be disposed at the terminal end of the channel and more specifically, between the base and the bottom of the sidewall(s) of the open-ended product.

The planter base attachment may further comprise a shelf for holding grow media deposited through another end of the open-ended product. The shelf may be disposed transversally with respect to the raised sidewall(s).

### BRIEF DESCRIPTION OF THE DRAWINGS

The embodiments of this invention are illustrated by way of example and not limitation in the figures of the accompanying drawings, in which like references indicate similar elements and in which:

FIG. 1 is a perspective view of an exemplary planter base attachment, according to one or more embodiments.

FIG. 2 is a section view of a planter base attachment being applied to a dual-walled corrugated pipe, according to one or more embodiments.

FIG. 3 is a section view showing an exemplary planter utilizing the planter base attachment, according to one or more embodiments.

FIG. 4 is a section view showing an exemplary planter top used to secure a liner, according to one or more embodiments.

FIG. 5A is a top view of the planter base attachment of FIG. 1, according to one or more embodiments.

FIG. 5B is a section view of a drainage groove of the planter base attachment of FIG. 1, according to one or more embodiments.

FIG. 5C is a top view of the drainage groove, according to one or more embodiments.

FIGS. 6A-D show a number of alternate planter base attachments.

Other features of the present embodiments will be apparent from the accompanying drawings and from the detailed description that follows.

### DETAILED DESCRIPTION

Various planter base attachments are provided in the detailed description set forth below in connection with the appended drawings. These embodiments are illustrative in nature and are not intended to represent the only configurations in which the concepts described herein may be practiced. The detailed description includes specific details for the purpose of providing a thorough understanding of various concepts. However, it will be apparent to those skilled in the art that these concepts may be practice without these specific details. Elements described herein as coupled may have a direct or indirect connection with one or more other intervening elements.

Aspects of the present disclosure provide one or more planter base attachments which may be utilized to repurpose a wide range of existing or manufactured products and materials, e.g., culvert pipes, drainage pipes, corrugated pipers, chimney flues, chimney pots, or any other open-ended products, to be used as a planter. Generally, the planter base attachment is configured to securely engage a portion of the interior sidewalls of such products, hold in growth media, and allow excess moisture to drain. The planter base attachment may be made of, for example, plastic, resin, rubber, cement, metal, or other materials.

Though the planter base attachments, open-ended products, and assembled planters described herein and illustrated in the figures may be shown as circular, it will be appreciated by a person of ordinary skill in the art that the concepts described herein may be used to retrofit the sidewalls of any shape, size, or material to seal in growth media and provide adequate drainage. For example, the open-ended product may be a reinforced concrete pipe having an elliptical shape. Or the open-ended product may be precast using an irregularly-shaped mold for a custom project. Or the open-ended product may be a topless and bottomless rectangular prism.

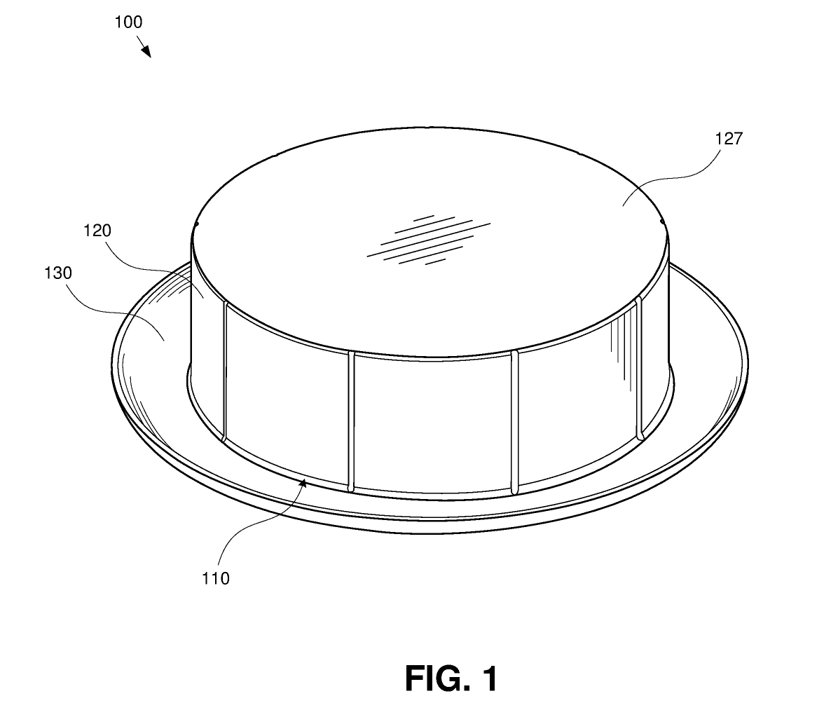

Referring to FIG. 1, an exemplary planter base attachment 100 is shown. In one embodiment, the planter base attachment 100 may comprise a base 110, a raised portion 120 of the base 110, a shelf 127 transverse to the raised portion 120, and a catchment tray 130. The base 110 may be shaped and/or sized according to the open-ended product the planter base attachment 100 is meant to fit.

The raised portion 120 comprises one or more sidewalls which extend from the base 110 and which may be inserted into one end of an open-ended product. The raised portion 120 is preferably shaped such that the profile of the raised portion 120 matches the aperture of the open-ended product. In this way, the raised portion 120 is able to engage the adjacent interior sidewalls of the open-ended product and secure the planter base attachment 100 to the open-ended product.

The planter base attachment 100 requires a surface disposed transversally across the raised portion 120 at least in part to retain growth media but also to add rigidity to the structure. Though any substantially horizontal surface would be able to retain grow media, its position relative to the base 110 may provide different properties to the planter base attachment 100 as will be discussed below.

In an embodiment shown in FIG. 1, the raised portion 120 may comprise a shelf 127 which spans the top rim of the sidewall(s). As such, the shelf 127 may withstand the weight of grow media, moisture, and plant matter and also provide structural support to the sidewalls of the raised portion 120. For example, applied to a cylindrical open-ended product, the raised portion 120 would be a raised ring extruded from base 110 and covered by a top surface, as shown in FIG. 1.

It will be appreciated by a person of ordinary skill in the art that the shelf 127 described above may be positioned in a number of configurations, i.e., at different heights and angles along the base 110 or the raised portion 120. However, a top surface coupling the top ends of a continuous wall (as shown in FIG. 1) may be preferable for at least the reason that it is a single continuous piece that is easier to manufacture. In any case, the shelf 128 is disposed transverse to the raised portion 120, i.e., the shelf 127 crosses the lateral sidewalls of the raised portion 120.

The planter base attachment 100 further comprises a catchment lip 130 which allows for collection and containment of planter drainage.

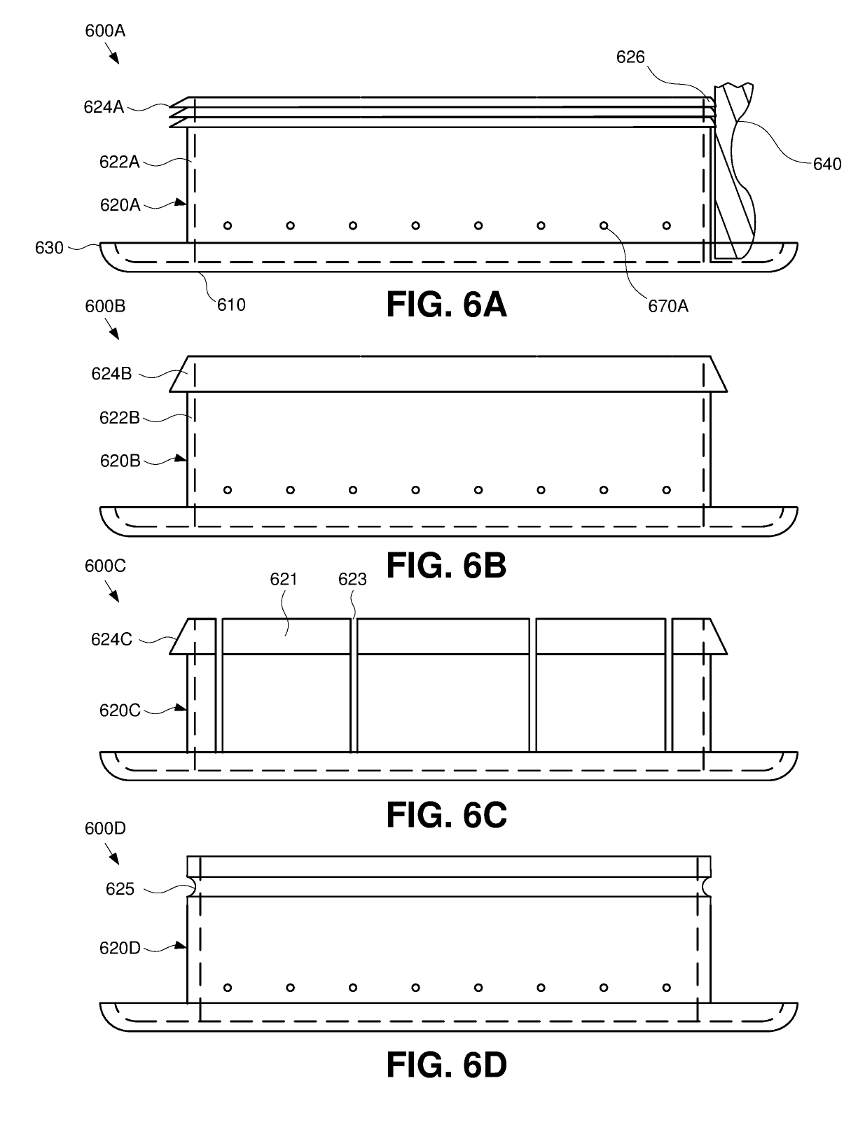

In another embodiment, the raised portion 120 may comprise a continuous sidewall coupled to a catchment saucer (please see FIGS. 6A-D), i.e., the shelf 127 would be disposed substantially within the same plane containing the base 110. For example, applied to a cylindrical open-ended product, the raised portion 120 would be a raised ring extruded from a flat base and would have an open top aperture.

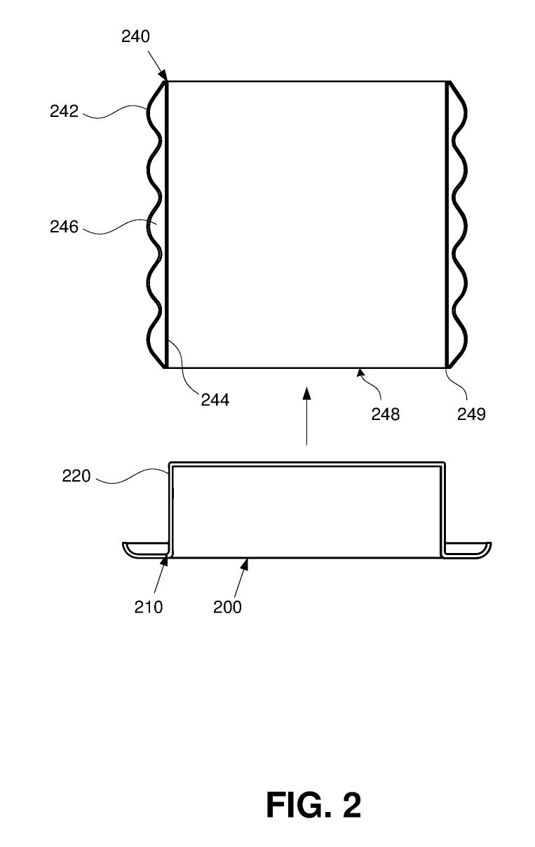

Referring to FIG. 2, a section view of a planter base attachment 200 applied to an open-ended product 240 is illustrated. The open-ended product 240 may be any object, product, or structure that can provide sidewalls for a planter. Examples of open-ended products suitable for this application include culvert pipes, corrugated pipes, drain pipes, chimney flues, chimney pots, and other open-ended products. Furthermore, sidewall materials of adequate strength and insulation properties may be manufactured to be suited to receive the open-ended product 240.

In some embodiments, such as the corrugated drain pipe shown in FIG. 2, the open-ended product may have an outer wall 242 and an inner wall 244 with one or more air pocket(s) 246 therebetween. The air pocket(s) 246 may serve as an insulating layer and may moderate potting soil and/or plant root temperatures. In other embodiments, the open-ended product 240 may comprise insulating material nested between the outer wall 242 and the inner wall 244.

At least a portion of the sidewalls of the open-ended product are preferably vertically aligned with the sides of the received raised portion 220 in order to maximize contact between the raised portion 220 and the open-ended product 240. To fit the planter base attachment 200 into the open-ended product 240, the raised portion 220 may be placed through one end 248 of the open-ended product 240. Once so fitted, the rim 249 of the open end 248 may fit snugly with the base 210. In order to facilitate this fitting, the raised portion 220 may be slightly smaller than the interior wall 244 of the open-ended product 240 to enable the outer lateral surface of the raised portion 220 to engage the interior wall 244.

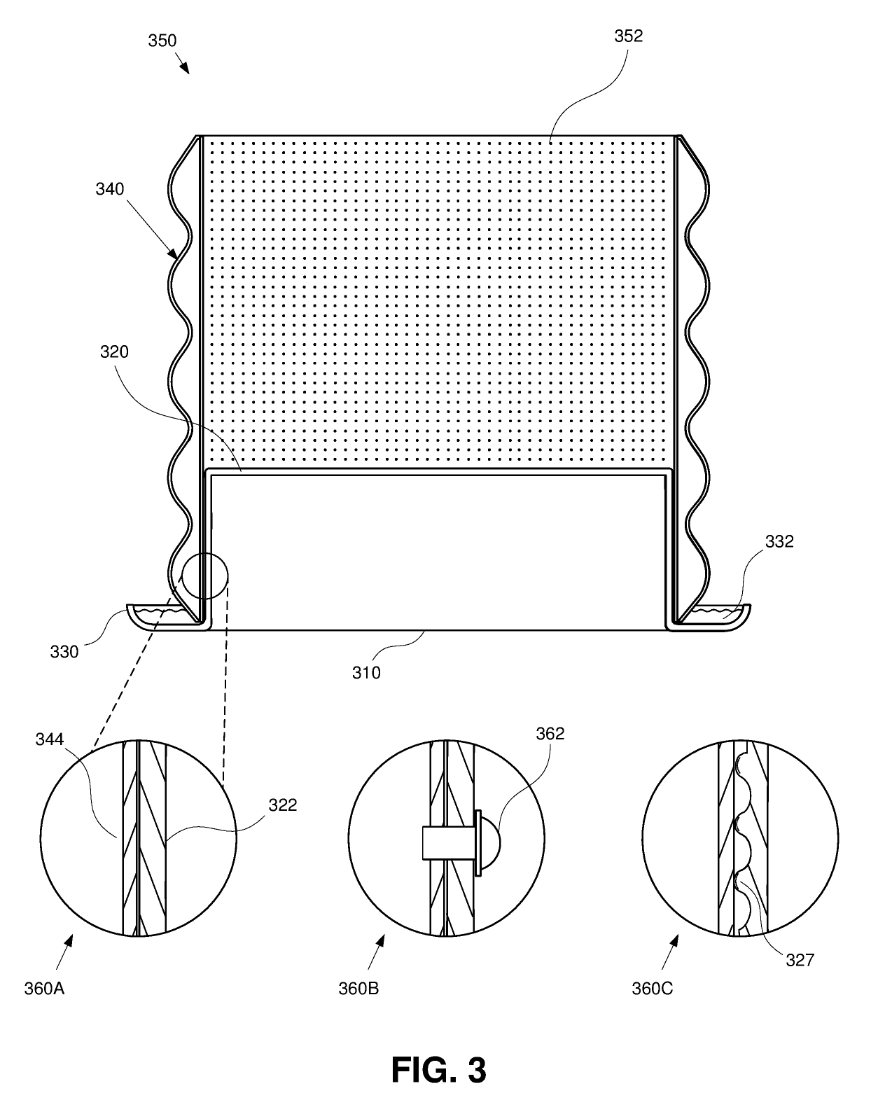

Referring to FIG. 3, an exemplary planter 350 comprising an open-ended product 340 fitted with a planter base attachment 300 is illustrated. As shown in FIG. 3, the open-ended product 340 fits the raised portion 320 of the base 310, thus allowing addition of a grow media 352. The raised portion 320 may be extended into the open-ended product 340 such that a sidewall 322 of the raised portion 320 engages the interior wall 344. In one embodiment, as shown in example 360A, friction is used to stabilize the planter base attachment 300.

However, a person of ordinary skill in the art may appreciate that other mechanical methods of securing a tight fit with the inner wall 344 are within the scope of the exemplary embodiments described herein. In example 360B, a rivet 362 may be used to fasten the raised portion 320 to the inner wall 344. Other fastening mechanisms may be used, such as screw or nut and bolt. In another example, as shown in example 360C, the sidewall 322 may be threaded. The space between the threads may serve as a spiraling channel for drainage.

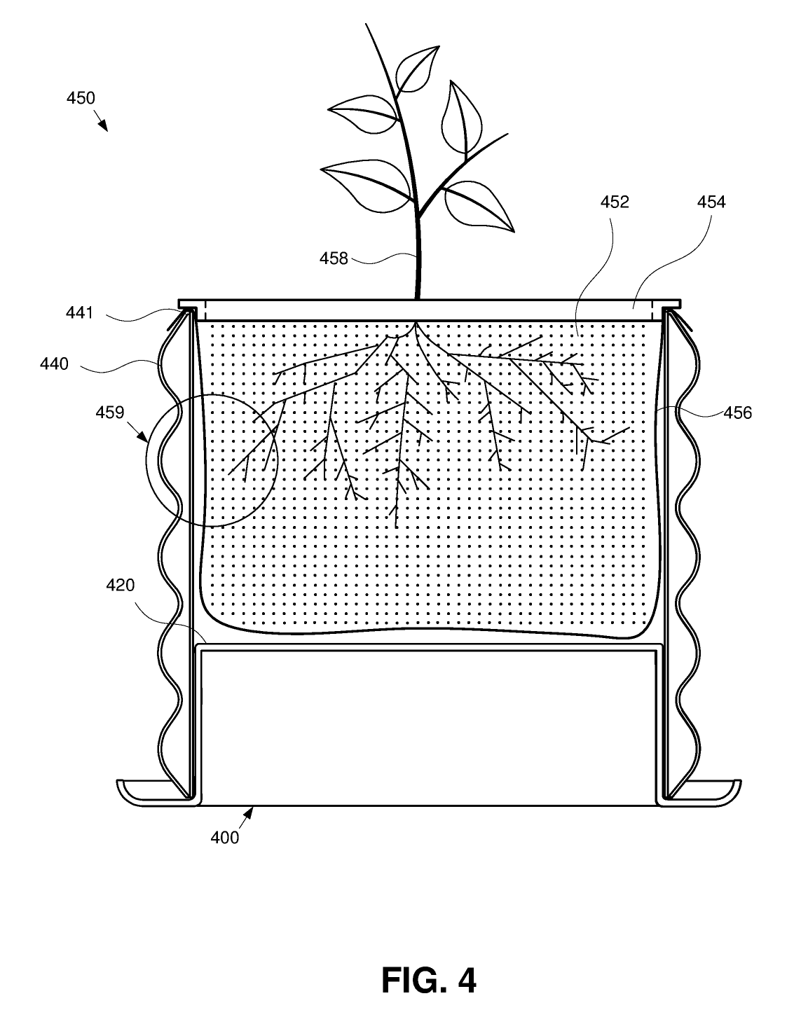

Referring to FIG. 4, a section view of a planter 450 is shown. In one embodiment, a resilient permeable liner 456 may be inserted into the planter 450, which comprises an open-ended product 440 fitted with a planter base attachment 400. The liner 456 may hold growth media 452 and may be held in place by a planter top 454, a portion of which rests on a rim 441 of the open-ended product 440. Another portion of the planter top 454 may extend somewhat into the open-ended product 440 to, for example, improve the planter top's grip on the top interior sidewalls of the open-ended product 440. This would also serve to better hold in place any intervening elements, such as the liner 456.

The liner 456 may be used to facilitate removal and recycling of the growth media 452. Additionally, the liner 456 may enhance planter drainage by preventing the growth media from partially blocking drainage channels or drainage holes. The liner 456 may be modified to provide an extra insulating layer for the grow media 452, which may regulate temperatures in the grow media 452 around, for example, a root zone 459 of a plant 458. This potential insulating effect may be compounded when used with an open-ended product 440 having internal and external walls, such as the drain pipe illustrated in FIG. 4. It would be appreciated by a person of ordinary skill in the art that other manufactured products having any number of walls, with or without internal gaps may be used in or modified for use in the exemplary embodiments described herein.

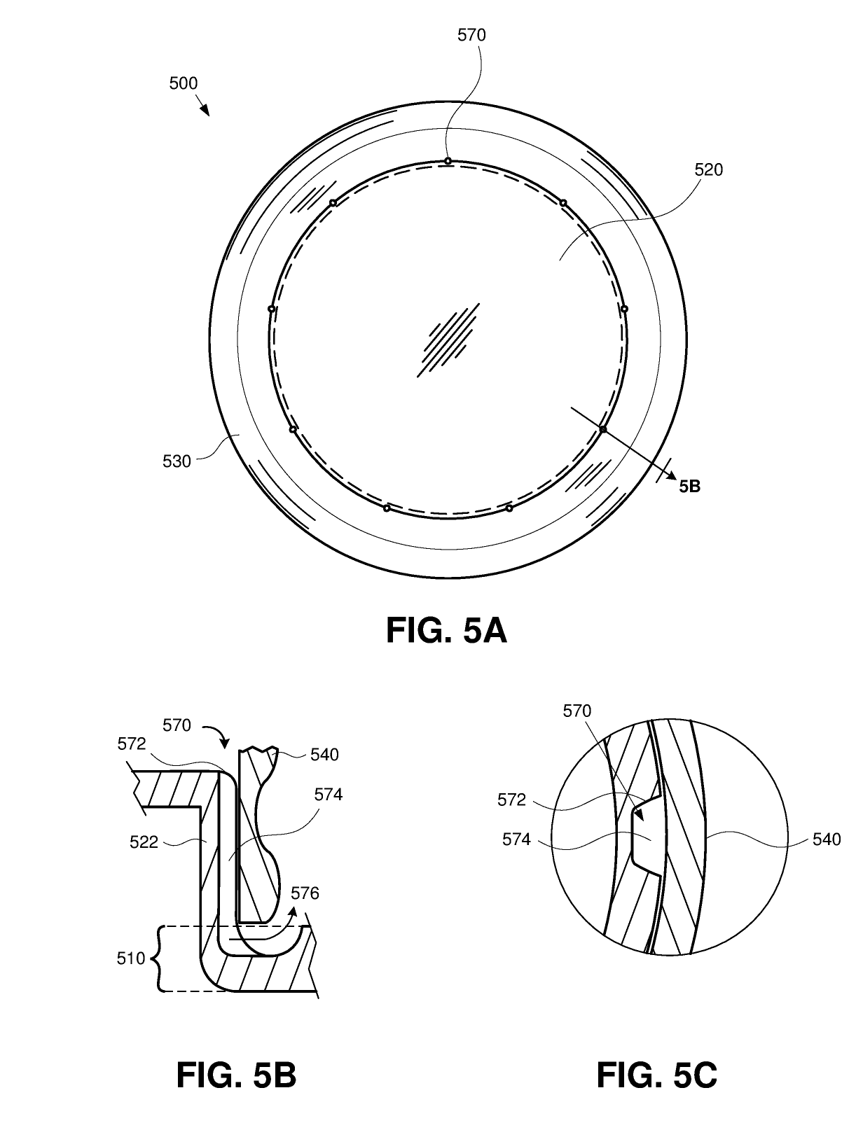

Referring to FIG. 5A, a top view of the planter base attachment 500 of FIG. 1 is shown. The raised portion 520 of the planter base attachment 500 may comprise inward drainage grooves 570 in its side walls, i.e., the surface of the raised portion 520 that directly contacts the inner sidewall(s) of the open-ended product. The drainage grooves 570 allow the planter base attachment 500 to drain excess moisture despite the raised portion 520 fitting against the inner wall of the open-ended product

Referring to FIG. 5B, a section view of the drainage groove 570 is shown. The drainage groove 570 may comprise an inlet 572, a channel 574, and an outlet 576. The bottom end of the open-ended product 540 may rest on the base 510 and/or may stay in place due to its engagement with the sidewall 522. The channel 574 may extend through the sidewall 522 and/or the base 510 to create an outlet 576 below and/or around the bottom of the open-ended product 540. It will be appreciated by a person of ordinary skill in the art that the drainage groove 570 may be implemented differently to achieve the same end, i.e., to create an open connection for fluids between the internal compartment of the planter and the catchment tray. For example, the channel 574 may not be vertically oriented. Or, the drainage groove 570 may utilize a physical feature of the open-ended product 540 to facilitate drainage.

Referring to FIG. 5C, a top view of the drainage groove 570 is shown. The drainage groove 570 provides enough clearance to allow water to pass through between the raised portion and the open-ended product despite their tight fit, as is shown in FIG. 5C.

Referring to FIGS. 6A-D, a number of alternate planter base attachments 600A-D having an open upper end are shown. In these embodiments, the shelf is in the same plane as the base 610. Thus, the planter base attachments 600A-D may allow grow media to be stored deeper since their respective raised portions are effectively raised rings coupled to a catchment saucer 630.

In one embodiment, a planter base attachment 600A as shown in FIG. 6A may comprise a base 610 to which a raised portion 620A may be coupled. The raised portion 620A comprises a rubber gasket 624 which may be configured to allow the raised portion 620A to be pushed into an open end of a product, but resist being pulled out from the open end. The rubber gasket 624A may comprise one or more compressible beveled edges 626 that may be oriented toward the open end of a receiving end of an open-ended product. When the sidewall 622A of the raised portion 620A engages the sidewall of, e.g., a corrugated open-ended product 640, the beveled edges 626 may compress and, due to their direction, allow the raised portion 620A to resist forces pulling the planter base attachment 600A out of the open-ended product 640, or the open-ended product 640 away from the planter base attachment 600A.

The raised portion 620A of the planter base attachment 600A may also comprise drainage routes 670A. Since growth media may fill the raised portion 620A, the drainage routes 670A may be a preferable means of draining excess moisture. Since the compressed beveled edges 626 effectively create a seal, the drainage routes 670A may be the most immediate route for excess fluids to take when the planter base attachment 600A is used in a planter.

The drainage routes 670A may be analogous to the drainage grooves 570 of FIG. 5 in that the drainage routes 670A also each comprise an inlet, a channel extending through the raised portion 620A, and an outlet. The inlet may be the inward-facing portion of the drainage route 670A. The outlet may be the portion of the drainage route 670A on the outside of the raised portion 620A. The channel may be the passage between the inlet and the outlet.

In another embodiment, a planter base attachment 600B as shown in FIG. 6B may comprise a beveled edge 624B which may be integral to the sidewall 622B of the raised portion 620B. When urged against the sidewalls of an open-ended product, the beveled edge 624B may create a tight seal. The planter base attachment 600B may also comprise drainage holes similar to those illustrated and described in FIG. 6A. The beveled edge 624B may be rigid or may yield slightly inward when pressed into an open-ended product.

In yet another embodiment, a planter base attachment 600C as shown in FIG. 6C may have a raised portion 620C made up of a plurality of segmented tabs 621 separated by gaps 623, each of which may subsequently comprise a beveled top edge 624C. The gaps 623 may extend partly or fully to the base 610. When the raised portion 620C is applied to an open end of an open-ended product, the gaps 623 may allow the segmented tabs 621 to bend inwardly, i.e., away from the interior sidewalls of the open-ended product, which subsequently causes the segmented tabs 621 to push outwardly, i.e., against the interior sidewalls of the open-ended product. The gaps 623 may also serve as drainage columns, allowing excess moisture to pass through them and into the catchment tray 630.

Also, in one embodiment, a planter base attachment 600D as shown in FIG. 6D may have a raised portion 620D comprising a continuous slot 625 within its sidewall. The continuous slot 625 may be fitted with a gasket, a lip, an O-ring, or other gripping modality which may allow the raised portion 620D to fit securely within an open-ended product. The continuous slot 625 may be outfitted with different materials based on the material of the receiving open-ended product or the material of the planter base attachment 600D.

The planter base attachment 600D may also comprise drainage holes similar to the planter base attachments of FIGS. 6A-B to drain excess moisture.

Various embodiments are described in this specification, with reference to the detailed discussed above, the accompanying drawings, and the claims. Numerous specific details are described to provide a thorough understanding of various embodiments. However, in certain instances, well-known or conventional details are not described in order to provide a concise discussion. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the embodiments.

The embodiments described and claimed herein and drawings are illustrative and are not to be construed as limiting the embodiments. The subject matter of this specification is not to be limited in scope by the specific examples, as these examples are intended as illustrations of several aspects of the embodiments. Any equivalent examples are intended to be within the scope of the specification. Indeed, various modifications of the disclosed embodiments in addition to those shown and described herein will become apparent to those skilled in the art, and such modifications are also intended to fall within the scope of the appended claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results.

What is claimed is:

1. A planter base attachment apparatus for converting an open-ended product into a planter, comprising:
a base comprising one or more raised sidewall(s) extending from the base,
wherein at least a portion of the raised sidewall(s) is configured to engage an interior surface of one or more sidewalls of one end of the open-ended product.

2. The device of claim 2, wherein at least one of the raised sidewall(s) comprises one or more drainage route(s), each drainage route comprising:
one or more inlets to accept excess moisture from within the planter,
one or more outlets to allow excess moisture to exit through the base, and
one or more channels extending through the raised sidewall(s) and configured to carry the excess moisture from at least one inlet to at least one outlet.

3. The device of claim 2, further comprising:
wherein each inlet is disposed at the top of the raised sidewall(s),
wherein each channel is a grooved portion of the raised sidewall(s), and
wherein each outlet is disposed at the terminal end of a channel and between the base and the bottom of the sidewall(s) of the open-ended product.

4. The device of claim 2, further comprising a catchment lip coupled to the base, wherein excess moisture drains from the drainage route(s) to the catchment lip.

5. The device of claim 1, further comprising a shelf disposed transverse to the raised sidewall(s).
